(19) United States
(12) Patent Application Publication
(10) Pub. No.: US 2013/0104510 A1
(43) Pub. Date: May 2, 2013

(54) COTTON HARVESTER SPINDLE

(71) Applicant: BRENT A. AUGUSTINE, East Moline, IL (US)

(72) Inventor: BRENT A. AUGUSTINE, East Moline, IL (US)

(21) Appl. No.: 13/285,104

(22) Filed: Oct. 31, 2011

(51) Int. Cl. A01D 46/16

(52) U.S. Cl. 56/41

(57) ABSTRACT

A cotton harvester spindle including a body rotatable about an axis in a direction of rotation. A tapered end having a tip and a plurality of barbs projecting in the direction of rotation. A flat gullet area extending between the adjacent barbs. The barbs having an axially outermost face angled toward the tip and an axially innermost sloping wall angled radially inwardly toward the flat gullet area. Wherein, the tapered end is covered with a coating selected from the group consisting of aluminum magnesium boride (AlMgB₁₄), aluminum magnesium boride comprising a dopant X (AlMgB₁₄:X), and diamond-like carbon.

### FIELD OF THE DISCLOSURE

The present disclosure generally relates to cotton harvesters, and more particularly to coatings for spindles of cotton harvesters.

### BACKGROUND OF THE DISCLOSURE

In order to harvest cotton, cotton harvesters commonly include a plurality of row units. Each row unit typically includes an upright picker drum having a plurality of spindle bars. The spindle bars rotatably mount spindles with barbs for picking cotton from cotton plants. The spindles are disclosed in commonly assigned U.S. Pat. No. 5,404,698, the entire contents of which are hereby incorporated by reference. The cotton-wrapped spindles pass under rotating doffer disks, which unwind the cotton and push the cotton off of the spindles.

The spindles are typically electroplated with greater than 45 microns of engineered hard chrome. The engineered hard chrome is hard (900-1100 HV) and corrosion resistant, which provides good wear resistance enabling a useful life of about 500 to 1000 hours. The engineered hard chrome has fairly low static and dynamic coefficients of friction, which provides a smooth, slick surface for cotton removal. However, the added thickness of the chrome reduces the sharpness of the barbs, which reduces the effectiveness of the spindle.

The engineered hard chrome electroplating process uses chromic acid, which contains hexavalent chromium ions that are plated to the spindle. Hexavalent chromium plating is known to leave a non-uniform coating with less on inside corners and more on edges such as the barbs, which reduces the sharpness of the barbs and the effectiveness of the spindle.

Alternative coatings are known that have improved hardness, lower coefficients of friction (improved slickness), and can be applied in thinner coatings. One such coating is the ceramic material aluminum magnesium boride of the general formula (AlMgB₁₄) as disclosed in U.S. Pat. Nos. 6,099,605 and 6,432,855. Al_{0.75}Mg_{0.78}B₁₄ is also contemplated by the general formula AlMgB₁₄. Aluminum magnesium boride including a dopant X of the general formula (AlMgB₁₄:X) is also known. The dopant X is added to improve the material properties of the ceramic material. Such improvements include, but are not limited to, increased hardness and lower coefficients of friction. The dopant is typically selected from the group consisting of Group III, IV, and V elements and the borides and nitrides derived from Group III, IV, and V elements. Aluminum magnesium boride is a ceramic and therefore inherently corrosion resistant. Aluminum magnesium boride is much harder than engineered hard chrome and is believed to provide a lower static and dynamic coefficient of friction than engineered hard chrome.

Another alternative coating is diamond-like carbon (DLC), which is available from Richter Precision Inc. of East Petersburg, Pa. One such DLC coating is metal-free DLC (C-DLC), which exhibits improved hardness and lower coefficients of friction. C-DLC can be applied using physical vapor deposition (PVD) including high power impulse magnetron sputtering PVD (HIPIMS PVD). C-DLC has a hardness of 2200 to 4000 HV and a coefficient of friction of 0.06 to 0.15.

### SUMMARY OF THE DISCLOSURE

In one embodiment, a cotton harvester spindle is disclosed. The spindle includes a body rotatable about an axis in a direction of rotation. A tapered end has a tip and a plurality of barbs projecting in the direction of rotation. A flat gullet area extends between the adjacent barbs. The barbs have an axially outermost face angled toward the tip and an axially innermost sloping wall angled radially inwardly toward the flat gullet area. The tapered end is covered with an aluminum magnesium boride (AlMgB₁₄) ceramic material. Alternatively, the spindle may be covered with a ceramic material comprising aluminum magnesium boride and a dopant X (AlMgB₁₄:X). The dopant may be titanium boride (TiB₂), boron carbide (B₄C), tungsten boride (W₂B₄), or carbon (C). Alternatively, the dopant is selected from the group consisting of Group III, IV, and V elements and the borides and nitrides derived from Group III, IV, and V elements. The dopant may be present in an amount of from 5 weight % to 30 weight %.

The spindle may be fabricated from steel and the ceramic material may be bonded to the steel. The ceramic material may be applied to the spindle using PVD or other processes. The ceramic material may have a thickness of from 1 to 5 microns. The ceramic material may have a hardness value of from 2800 to 3800 HV.

In another embodiment, a cotton harvester spindle is disclosed where substantially the entire cotton harvester spindle is covered with the aluminum magnesium boride (AlMgB₁₄) ceramic material. Alternatively, the spindle may be covered with a ceramic material comprising aluminum magnesium boride and a dopant X (AlMgB₁₄:X), as discussed above.

In yet another embodiment, a cotton harvester spindle is disclosed where a tapered end is covered with a coating selected from the group consisting of aluminum magnesium boride (AlMgB₁₄), aluminum magnesium boride comprising a dopant X (AlMgB₁₄:X), and diamond-like carbon. Alternatively, substantially the entire cotton harvester spindle may be covered by the coating. The diamond-like carbon material may be C-DLC.

### BRIEF DESCRIPTION OF THE DRAWINGS

FIG. 1 is an enlarged elevational view of a cotton harvester spindle according to one embodiment showing a tapered end covered by a coating with thickness exaggerated for clarity.

FIG. 2 is a sectional view of the cotton harvester spindle of FIG. 1 taken along lines 2-2, showing the coating with thickness exaggerated for clarity.

FIG. 3 is an enlarged view of the tapered end of the spindle of FIG. 1.

FIG. 4 is a view taken along lines 4-4 of FIG. 3, showing a barb.

FIG. 5 is an enlarged elevational view of a cotton harvester spindle according to another embodiment showing the entire spindle covered by a coating with thickness exaggerated for clarity.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### DETAILED DESCRIPTION

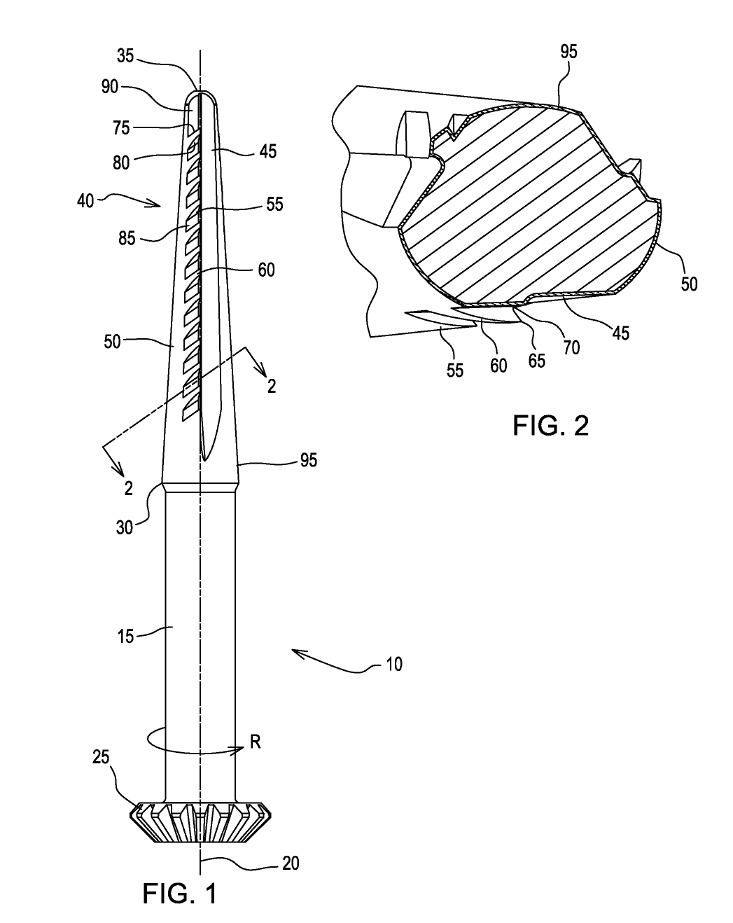

FIG. 1 illustrates a cotton harvester spindle 10. The illustrated cotton harvester spindle 10 includes a cylindrically-shaped bearing portion 15 that is concentric with a longitudinal axis 20 and supported in a bushing in a spindle bar (not shown). A gear 25 is located at the end of the bearing portion 15. The gear 25 engages a complimentary gear (not shown) in the spindle bar to rotate the spindle 10 in the direction R about the axis 20.

At a location 30, the spindle 10 tapers towards a rounded tip 35 to define a tapered end 40. The spindle 10 includes three sets of alternating flutes 45 and rounded lands 50 equally spaced about the periphery of the tapered end 40. The flutes 45 lie radially inwardly of the rounded lands 50. A plurality of barbs 55 project over the flutes 45. The barbs 55 include upper surfaces, or tops 60, which lie along the surface of the tapered end 40 described by the continuation of the lands 50.

The barbs 55 include pointed tip portions 65, which lie substantially along the surface of the tapered end 40 described by the continuation of the lands 50. The barbs 55 project in the direction of rotation R over the corresponding flutes 45 and are undercut at locations 70. The barbs 55 include an outer or leading wall 75 which is substantially planar. The leading wall 75 is normal to the flute 45 and is angled forwardly in the direction of rotation R. The top 60 of each barb 55 extends axially inwardly, in the direction of the gear 25, from the leading wall 75 to a back wall 80. The back wall 80 slopes radially and axially inwardly and terminates at a juncture with a planar gullet area 85 which extends from the back wall 80 to the leading wall 75 of the next barb 55. The gullet areas 85 lie substantially in a plane parallel to but offset radially outwardly a small distance from the flute 45. An area 90 axially outward of the outermost barb 55 extends in the plane of the gullet areas 85 to the tip 35. Twelve barbs 55 are spaced equidistantly along the length of each flute 45. Alternatively, any number of barbs 55 could be used.

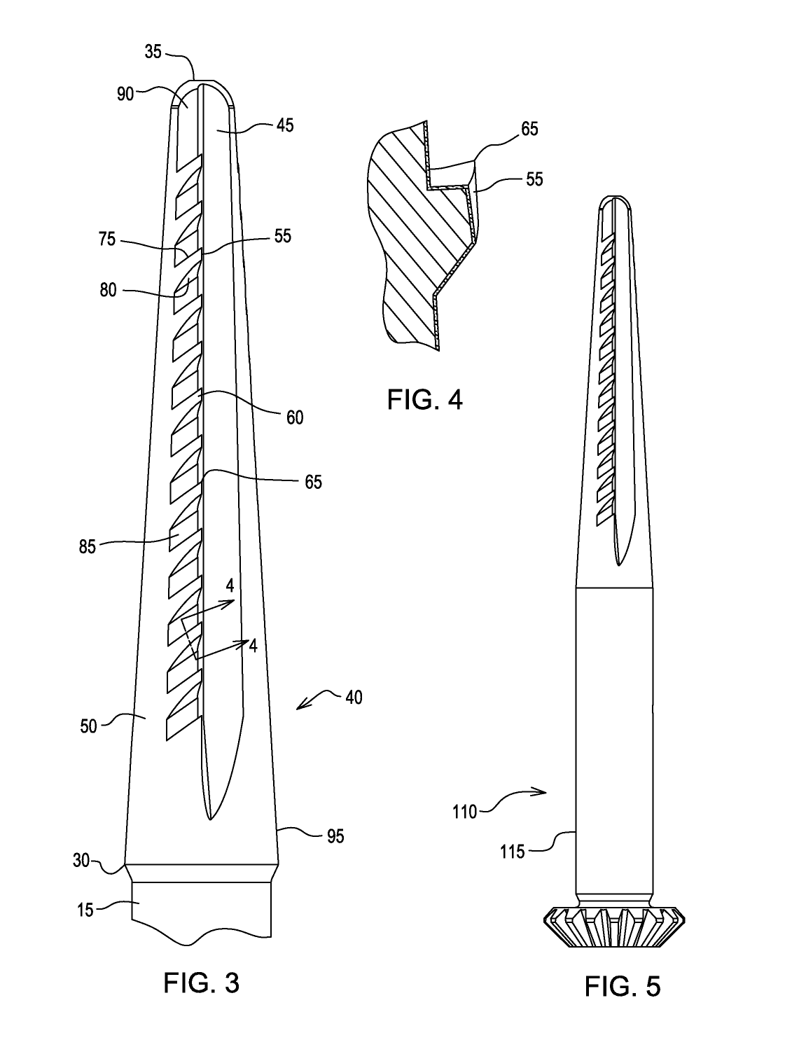

With reference to FIGS. 1-4, the tapered end 40 is covered with a coating 95. Referring to FIG. 4, preferably the coating 95 is very thin as compared with the dimensions of the barbs 55 so that the effective shape of the barbs 55 and the pointed tip portion 65 remain substantially unaltered. In the illustrated embodiment, the coating 95 is aluminum magnesium boride (AlMgB₁₄) and is 1 to 5 microns thick.

In operation, the complimentary gear in the spindle bar rotates the gear 25, which rotates the spindle 10 in the direction R about the axis 20. The barbs 55 engage cotton of a cotton plant (not shown) and the cotton wraps around the spindle 10. The cotton is then doffed from the spindle 10 by rotating doffer disks (not shown), which unwind the cotton and push the cotton off of the spindle 10.

Advantageously, the very thin coating 95 maintains a sharp pointed tip portion 65 on each barb 55 and is believed to improve the effectiveness of the spindle 10 at picking cotton. The coating 95 is believed to provide a smoother and slicker surface by lowering the static and dynamic coefficients of friction of the spindle 10, which enables better doffing action. The coating 95 increases the hardness of the spindle 10, which is believed to increase the useful life of the spindle 10.

FIG. 5 illustrates a cotton harvester spindle 110 according to another embodiment. The spindle 110 includes features similar to the spindle 10 of FIGS. 1-4, and therefore, only differences between the spindles 10 and 110 will be discussed in detail below. In this embodiment, substantially the entire spindle 110 is covered with a coating 115. In the illustrated embodiment, the coating 115 is aluminum magnesium boride (AlMgB₁₄) and is 1 to 5 microns thick.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

Various features are set forth in the following claims.

What is claimed is:

1. A cotton harvester spindle comprising:
a body rotatable about an axis in a direction of rotation;
a tapered end having a tip and a plurality of barbs projecting in the direction of rotation; and
a flat gullet area extending between the adjacent barbs, the barbs having an axially outermost face angled toward the tip and an axially innermost sloping wall angled radially inwardly toward the flat gullet area;
wherein the tapered end is covered with an aluminum magnesium boride (AlMgB₁₄) ceramic material.

2. The cotton harvester spindle of claim 1, wherein the tapered end is fabricated from steel and the ceramic material is bonded to the steel.

3. The cotton harvester spindle of claim 1, wherein the ceramic material further comprises a dopant of titanium boride (TiB₂).

4. The cotton harvester spindle of claim 3, wherein the dopant of titanium boride (TiB₂) is present in an amount of from 5 weight % to 30 weight %.

5. The cotton harvester spindle of claim 1, wherein the ceramic material further comprises a dopant of boron carbide (B₄C).

6. The cotton harvester spindle of claim 5, wherein the dopant of boron carbide (B₄C) is present in an amount of from 5 weight % to 30 weight %.

7. The cotton harvester spindle of claim 1, wherein the ceramic material further comprises a dopant of tungsten boride (W₂B₄).

8. The cotton harvester spindle of claim 7, wherein the dopant of tungsten boride (W₂B₄) is present in an amount of from 5 weight % to 30 weight %.

9. The cotton harvester spindle of claim 1, wherein the ceramic material further comprises a dopant of carbon (C).

10. The cotton harvester spindle of claim 9, wherein the dopant of carbon (C) is present in an amount of from 5 weight % to 30 weight %.

11. The cotton harvester spindle of claim 1, wherein the ceramic material has a thickness of from 1 to 5 microns.

12. The cotton harvester spindle of claim 1, wherein the ceramic material has a hardness value of from 2800 HV to 3800 HV.

13. A cotton harvester spindle comprising:
a body rotatable about an axis in a direction of rotation;
a tapered end having a tip and a plurality of barbs projecting in the direction of rotation; and
a flat gullet area extending between the adjacent barbs, the barbs having an axially outermost face angled toward the tip and an axially innermost sloping wall angled radially inwardly toward the flat gullet area;
wherein the tapered end is covered with an aluminum magnesium boride (AlMgB₁₄:X) ceramic material comprising a dopant X selected from the group consisting of Group III, IV, and V elements and the borides and nitrides derived from Group III, IV, and V elements.

14. The cotton harvester spindle of claim 13, wherein the dopant is carbon (C).

15. The cotton harvester spindle of claim 13, wherein the spindle is fabricated from steel and the ceramic material is bonded to the steel.

16. The cotton harvester spindle of claim 13, wherein the dopant is present in an amount of from 5 weight % to 30 weight %.

17. The cotton harvester spindle of claim 13, wherein the ceramic material has a thickness of from 1 to 5 microns.

18. The cotton harvester spindle of claim 13, wherein the ceramic material has a hardness value of from 2800 HV to 3800 HV.

19. A cotton harvester spindle comprising:
a body rotatable about an axis in a direction of rotation;
a tapered end having a tip and a plurality of barbs projecting in the direction of rotation; and
a flat gullet area extending between the adjacent barbs, the barbs having an axially outermost face angled toward the tip and an axially innermost sloping wall angled radially inwardly toward the flat gullet area;
wherein the tapered end is covered with a coating selected from the group consisting of aluminum magnesium boride (AlMgB₁₄), aluminum magnesium boride comprising a dopant X (AlMgB₁₄:X), and diamond-like carbon.

20. The cotton harvester spindle of claim 19, wherein the dopant X is selected from the group consisting of Group III, IV, and V elements and the borides and nitrides derived from Group III, IV, and V elements.

21. The cotton harvester spindle of claim 19, wherein the coating has a thickness of from 1 to 5 microns.

22. The cotton harvester spindle of claim 19, wherein substantially the entire cotton harvester spindle is covered with the coating.
